(19) United States
(12) Patent Application Publication
(10) Pub. No.: US 2015/0201150 A1
(43) Pub. Date: Jul. 16, 2015

(54) VIDEO OUTPUT DEVICE

(71) Applicant: Panasonic Intellectual Property Management Co., Ltd., Osaka (JP)

(72) Inventors: Masayuki KIMURA, Osaka (JP); Hidetoshi TAKEDA, Osaka (JP); Yoshiyuki OKIMOTO, Nara (JP); Takayoshi KOYAMA, Osaka (JP)

(21) Appl. No.: 14/667,654

(22) Filed: Mar. 24, 2015

Related U.S. Application Data
(63) Continuation of application No. PCT/JP2013/005371, filed on Sep. 11, 2013.

(30) Foreign Application Priority Data
Sep. 28, 2012 (JP) 2012-215897

(51) Int. Cl. H04N 5/445

(52) U.S. Cl. CPC H04N 5/44591; H04N 5/44508

(57) ABSTRACT

A video output device according to the present disclosure synthesizes a plurality of videos into a video to be displayed. The video output device includes image processing unit and output unit. The image processing unit extracts a plurality of reference frames from any one reference video selected from the plurality of the videos captured by an imaging unit, and extracts a corresponding frame, most similar to a respective one of the reference frames, from each of the videos excluding the reference video. The output unit outputs a synthesized frame which image processing unit synthesizes from the each of the reference frame and the corresponding frame.

### BACKGROUND

1. Field

The present disclosure relates to video output devices which synthesize a plurality of videos into a video, thereby allowing the videos to be displayed on the same screen.

2. Description of the Related Art

Simultaneous reproduction of a plurality of videos to compare them is commonly practiced. In an area of sports training, for example, applications of such a simultaneous reproduction are expected to allow various comparisons including: a comparison between a trainee's motion and an example motion and a comparison between a current motion and a motion in prime condition.

Patent Literature 1 discloses a video recording/reproducing device which features the following functions. That is, the device records a plurality of video signals and detects specific phenomena to which attention should be paid when the signals are reproduced, with the device also recording time information of the moments of occurrence of the phenomena. Then, when reproducing the video signals, the device controls reproduction timing such that the phenomena are approximately simultaneously displayed. Use of the device described in Patent Literature 1 allows the reproduction of videos in such a manner that: When comparing forms of golf swing, for example, moments of impacts recorded in the videos are displayed approximately simultaneously.

### CITATION LIST

### Patent Literature

PTL 1: Japanese Patent Unexamined Publication No. H06-162736

### SUMMARY

A video output device according to the present disclosure synthesizes a plurality of videos into a video to be displayed. The video output device includes an image processing unit and an output unit. The image processing unit extracts a plurality of reference frames from any one reference video selected from the plurality of the videos captured by an imaging unit, and extracts a frame, most similar to a respective one of the reference frames corresponding, from each of the videos excluding the reference video. The output unit outputs a synthesized frame which the image processing unit synthesizes from the each of the reference frame and the corresponding frame.

### BRIEF DESCRIPTION OF DRAWINGS

FIG. 1 is a block diagram of a configuration of a video output device according to an embodiment of the present disclosure;

FIG. 2 is a flowchart illustrating a flow of video output processing performed by the video output device according to the embodiment;

FIG. 3 is a flowchart illustrating a process flow of extracting a corresponding frame;

FIG. 4 is a schematic view to illustrate a case where two videos S1 and S2 of golf swings are arranged on the same time base;

FIG. 5 is a schematic view to illustrate a case where reproduction start positions are adjusted such that the start timings of swing motions are concurrent;

FIG. 6 is a schematic view to illustrate a case where the videos are extended and/or contracted on the time base such that the timings are adjusted to be concurrent;

FIG. 7 is a schematic view to illustrate a case where a video is discretized on to frames; and

FIG. 8 is a schematic view to illustrate a case where the time period of a frame is long.

### DETAILED DESCRIPTION

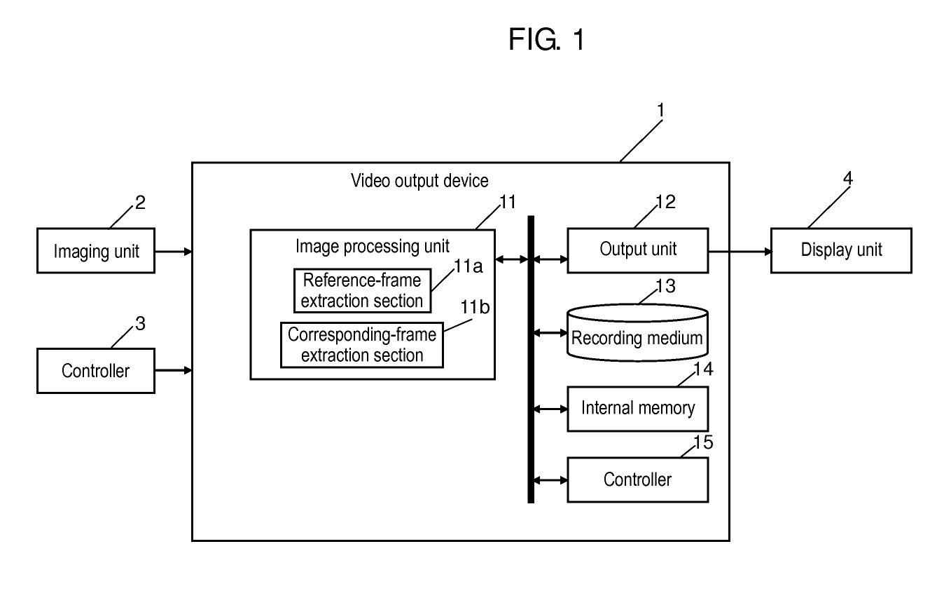

Hereinafter, descriptions will be made regarding a video output device according to an embodiment of the present disclosure, with reference to FIGS. 1 to 8. It is noted, however, that descriptions in more detail than necessary will sometimes be omitted. For example, detailed descriptions of well-known items and duplicate descriptions of substantially the same configuration will sometimes be omitted, for the sake of brevity of the following descriptions and easy understanding by those skilled in the art.

Note that the inventers provide the accompanying drawings and the following descriptions so as to facilitate fully understanding of the present disclosure by those skilled in the art, and have no intention of imposing any limitation on the subject matter set forth in the appended claims.

### 1.1. Configuration

FIG. 1 is a block diagram of a configuration of the video output device according to the embodiment of the present disclosure.

As shown in FIG. 1, video output device 1 is coupled, via means capable of data transmission, with imaging unit 2 such as a video camera to capture an image, controller 3 for a user to direct operations of video output device 1, and display unit 4 such as an external display monitor to display video information output from video output device 1. With this configuration, video output device 1 performs an operation of synthesizing a plurality of videos, which are captured with imaging unit 2, into a video to be displayed on display unit 4. Controller 3 is intended to direct operations which includes, for example, selecting a plurality of videos to be reproduced and selecting a reference video from the videos to be reproduced. The controller is configured with input devices including a keyboard and a mouse.

Moreover, video output device 1 includes image processing unit 11, output unit 12, recording medium 13, internal memory 14, and controller 15 configured with a CPU, with each of these parts being capable of data transmission among them via a bus line.

Image processing unit 11 includes reference-frame extraction section 11a and corresponding-frame extraction section 11b. The reference-frame extraction section extracts a plurality of reference frames from any one reference video that is selected from the plurality of the videos captured with imaging unit 2. From each of the videos excluding the reference video, the corresponding-frame extraction section extracts a corresponding frame which is the most similar to each reference frame. With this configuration, image processing unit 11 performs various kinds of image processing including the operations of extracting the frames from the videos, judging similarities between the frames, and generating a synthesized frame in which each of the reference frames and the corresponding frame are arranged to be displayed on the same display screen, with the corresponding frame being extracted corresponding to the each of the reference frames. Image processing unit 11 is configured with a signal processor such as a digital signal processor (DSP) or a microcomputer, or alternatively configured with a combination of a signal processor and software.

Moreover, output unit 12 is intended to output the synthesized frame that image processing unit 11 synthesizes from each reference frame and the corresponding frame. Recording medium 13 is intended to record, in advance, video data to be reproduced, or to record the synthesized frame generated by output unit 12 as a still image or video data. The recording medium is configured with such as a hard disk. Internal memory 14 is used as a working memory for image processing unit 11 and output unit 12, and is configured with DRAM or the like. Controller 15 serves as a means for controlling the operation of the whole of video output device 1.

### 1-2. Operation

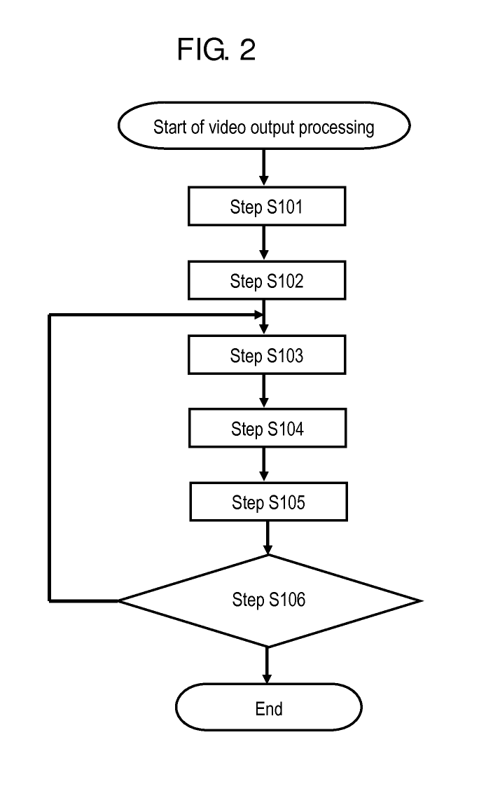

A description will be made regarding operations of the video output device configured as described above according to the embodiment, with reference to FIG. 2. FIG. 2 is a flowchart illustrating a flow of video output processing performed by the video output device according to the embodiment.

First, as shown in FIG. 2, a user starts by operating controller 3 to select a plurality of videos to be reproduced (Step S101). Then, the user determines one reference video from the plurality of the videos which have been selected in Step S101 (Step S102). Instead of such a reference video determined by the user through the use of controller 3, the reference video may be any one of the plurality of the videos which have been selected in Step S101.

Then, image processing unit 11 extracts reference frames from the designated reference video (Step S103). The extraction of the reference frames can be performed by a method of, such as, extracting frames as the reference frames from the reference video at predetermined regular time intervals, or averaging the predetermined number of consecutive ones of the frames of the reference video to form and extract the reference frames.

Next, from each of the videos excluding the reference video, one frame showing the maximum similarity to a respective one of the reference frames is extracted as a corresponding frame (Step S104). A specific procedure for extracting the corresponding frame will be described later.

After having extracted the corresponding frame, image processing unit 11 synthesizes the reference frame and the corresponding frame into a synthesized frame to be output (Step S105).

Finally, the image processing unit judges whether or not either of the videos reaches the end (Step S106). When neither of the videos reaches the end, the unit repeats Step S103 and the following steps.

### Specific Procedure for Extracting Corresponding Frame

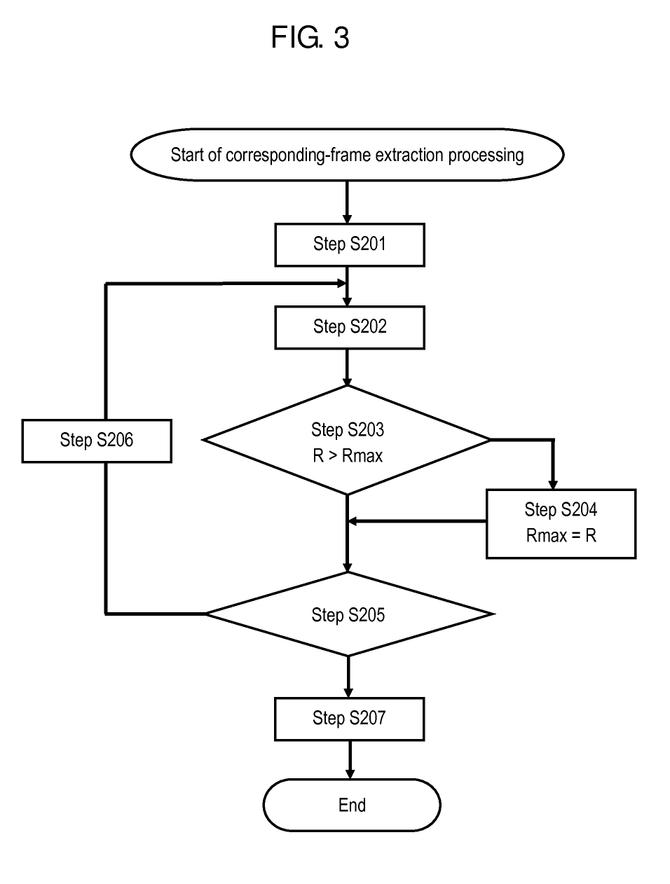

Hereinafter, a procedure for extracting the corresponding frame will be described with reference to FIG. 3. FIG. 3 is a flowchart illustrating a process flow of extracting the corresponding frame.

As shown in FIG. 3, an initialization is performed in such a manner that:

The position of a search frame, a subject of similarity calculation, is set equal to the position of the corresponding frame that has been extracted immediately before this moment. In addition, maximum similarity Rmax is initialized to be zero (Step S201).

Next, similarity R is calculated between the reference frame extracted in Step S103 of FIG. 2 and the search frame (Step S202). The method for calculating the similarity may be one in which the similarity of a frame to the reference frame is calculated based on differences in pixel values between the frames. For example, a common procedure for calculating a similarity between images can be adopted which uses differences in sum of absolute differences (SAD) or sum of squared differences (SSD) of the pixel values, differences in motion vectors between the reference frame and the search frame, autocorrelation coefficients of the images, or the like.

Note that, among such procedures for calculating similarity R, some of them use indexes, such as SAD or SSD of the pixel values or differences in motion vectors, which become larger in value with decreasing similarity between the images concerned. In these procedures, the indexes are preferably converted to be ones which become larger in value with increasing similarity between the images, by taking an inverse of each of the indexes, i.e. taking the each to the power of (−1), or the like.

Moreover, when the similarity between the search frame and the reference frame is calculated based on the motion vectors between the frames, the procedure is preferably performed in such a manner that: The motion vectors of the reference frame are “the motion vectors between the latest reference frame and the reference frame extracted immediately before this moment,” whereas the motion vectors of the search frame are “the motion vectors between the latest search frame and the corresponding frame extracted immediately before this moment.”

The similarity R calculated in this way is compared with the maximum similarity Rmax that has been obtained so far (Step S203). When the calculated similarity R is greater than the maximum similarity Rmax, the value of the maximum similarity Rmax is replaced by the calculated similarity R, and the position of the search frame at this moment is stored (Step S204).

Then, the position of the current search frame is judged whether or not to have reached the end of a predetermined search range (Step S205). When the position is judged not to have reached the end, a process is performed so that the position of the search frame proceeds by one frame to the next (Step S206). After the position of the search frame has proceeded by one frame, the process for calculating similarity R is performed again in Step S202. When the position is judged to have reached the end, the frame located at the position corresponding to maximum similarity Rmax is extracted as the corresponding frame (Step S207).

The process flow described above allows the extraction of the corresponding frame.

It is noted, however, that the search range is set such that the search is performed for, such as, the predetermined number of the frames or the number of the frames involved in a predetermined period of time. More preferably, a user can designate the way for setting the search range, through the use of controller 3.

### Modified Example of Procedure of Extracting the Corresponding Frame

In the embodiment, the description has been made using the example where the frame showing maximum similarity R is extracted as the corresponding frame. A modified example may be one in which a plurality of the frames contained in the same video are averaged to form a frame to be extracted as the corresponding frame such that similarity R of the thus-obtained corresponding frame to the reference frame becomes the maximum. In particular, in the case where the reference frame is extracted by averaging a plurality of the frames, such a procedure adopted in the modified example makes it possible to increase similarity R, in comparison with the procedure in which similarity R is obtained through a comparison between a sole search frame and the extracted-by-averaging reference frame.

### 1-3. Advantages and Others

Advantages of the embodiment according to the present disclosure will be described using an example where videos of motions of golf swing; are processed and output.

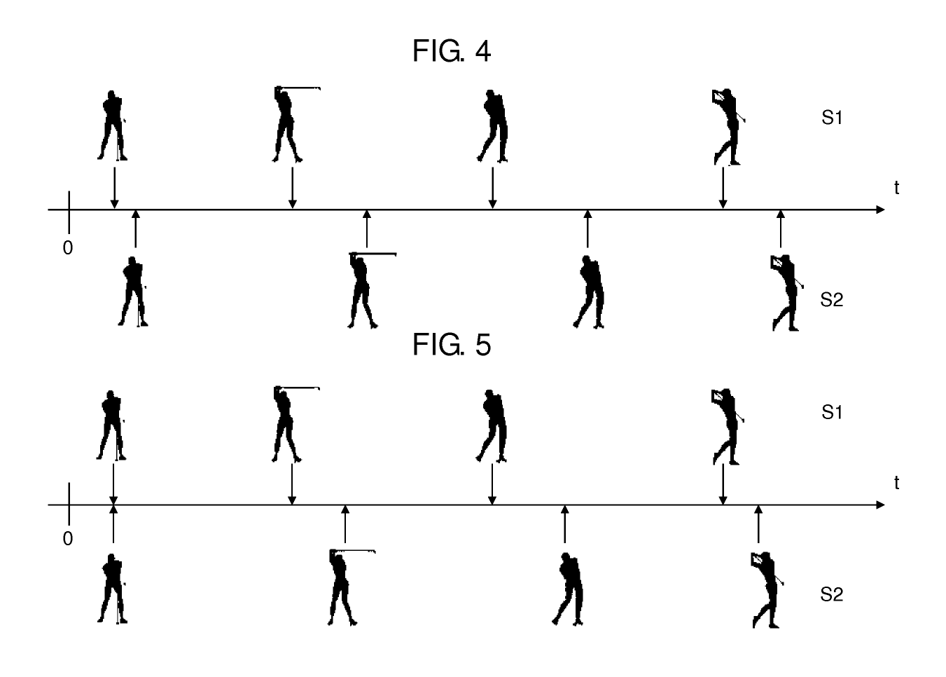

FIG. 4 is a schematic view to illustrate a case where two videos S1 and S2 of golf swings are arranged on the same time base. Note that, in the figure, only typical parts of the swing motions are shown. When the two videos are simultaneously reproduced starting at the same point in time of t=0 (zero), timings of the two motions are not concurrent at every point.

On the other hand, FIG. 5 is a schematic view to illustrate a case where the start positions of the reproduction are adjusted such that the start timings of the swing motions are concurrent. Although video S2 is shifted as a whole toward the left in comparison with that in FIG. 4, only the starting timings of the motions are adjusted to be concurrent, with the other timings still remaining to be not concurrent. This is because the adjustment is made only for the reproduction start positions.

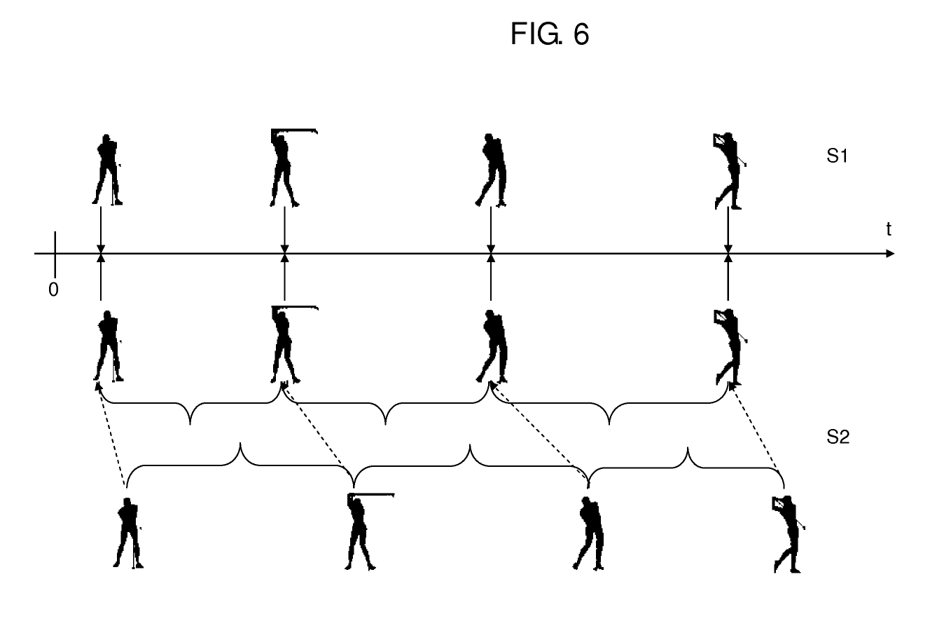

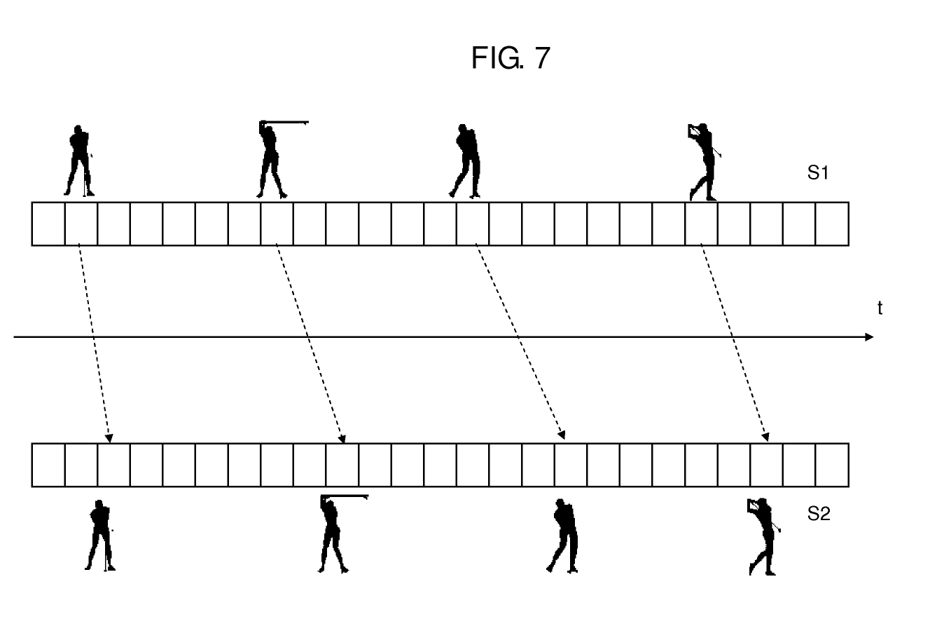

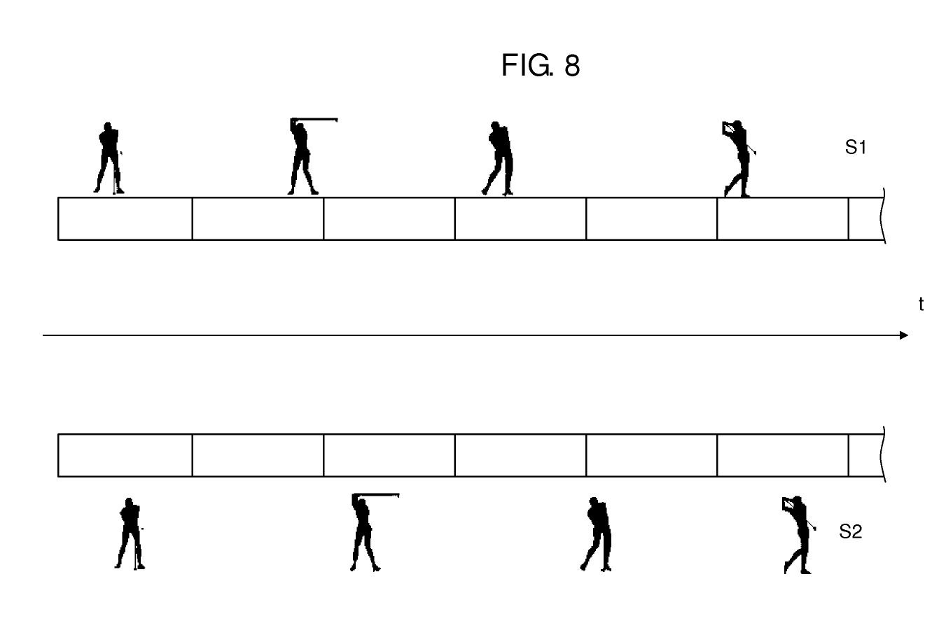

FIG. 6 is a schematic view to illustrate a case where the videos are extended and contracted on the time base such that the timings are adjusted to be concurrent. FIG. 7 is a schematic view to illustrate a case where a video is discretized to frames. FIG. 8 is a schematic view to illustrate a case where the time period of one frame is long.

As shown in FIG. 6, in order to reproduce the videos with the timings being concurrent over the entire videos, video S2 as a whole is extended and/or contracted in time to cause the timing of each of the points of video S2 to be concurrent with the corresponding point of video S1.

It is noted, however, that the performing of such an image processing is practically subjected to constraints of a frame rate of each video. Because each of the frames of a common moving image is discretized on the time base, the resolution of extension and/or contraction of the moving image on the time base is equal to the time resolution of the frame, as shown in FIG. 7. Moreover, as shown in FIG. 8, when the time period of one frame is long, i.e. the frame rate of the video concerned is low, time lags of the timings become shorter than the time period of one frame, resulting in difficult adjustment via such the extension and/or contraction on a frame unit basis. Therefore, the video captured with the imaging unit is preferably captured at a higher frame rate than the frame rate of the output from the output unit, thereby increasing the resolution of the extension and/or contraction on the time base.

The video output device according to the present disclosure includes the image processing unit and the output unit. The image processing unit extracts a plurality of the reference frames from any one reference video that is selected from a plurality of the videos captured with the imaging unit, and extracts the corresponding frames, each of which is most similar to a respective one of the reference frames, from each of the videos excluding the reference video. The output unit outputs the synthesized frames which the image processing unit has synthesized from the reference frames and the corresponding frames.

With this configuration, given a specific reference video selected from the plurality of the videos captured with the imaging unit, a similar video to the specific reference video can be extracted from the other remaining videos. Then, both the specific reference video and the extracted similar video can be reproduced simultaneously, with the timings of the both being concurrent over the entire videos.

In some cases, moreover, the timings are preferably adjusted to be concurrent not only at a specific moment but also over the entire period of a motion. Such cases include one where videos of motions with different speeds are compared with each other and one where differences are taken between the frames of videos to clarify a different part between them. In these cases, it is considered that the difference in speed between the motions is not constant at each stage of the motions and that such a difference in speed shows fluctuations in time. The video output device according to the present disclosure includes the image processing unit that extracts a plurality of the reference frames from any one reference video and then extracts the corresponding frames, each of which is most similar to the respective one of the reference frames, from each of the videos excluding the reference video. This configuration allows the display in which a plurality of the videos showing motions with fluctuations in time can be displayed approximately simultaneously, with the fluctuations being accommodated automatically.

As described above, given a specific reference video selected from the videos captured with the imaging unit, the video output device according to the present disclosure is capable of extracting a similar video to the reference video from the other remaining videos, and reproducing both the specific reference video and the similar video, with the timings of the both being concurrent over the entire videos. This configuration allows an increased customer convenience in comparing motions with each other by using the videos of the motions.

### Other Exemplary Embodiments

As described above, the embodiment has been described to exemplify the technology disclosed in the present application. However, the technology disclosed herein is not limited to the embodiment, and is also applicable to embodiments that are subjected, as appropriate, to various changes and modifications, replacements, additions, omissions, and the like. Moreover, the technology also allows another embodiment which is configured by combining the appropriate constituent elements in the embodiment described above.

Then, other embodiments will be exemplified hereinafter.

Although the embodiment described above is focused on the case where the two videos are used, three or more of videos may be used. In this case, for a given one reference video, corresponding frames are extracted from each of the remaining videos, thereby allowing a simultaneous display of a more number of the videos.

Moreover, the number of the reference videos is not limited to one; there may be a plurality of the reference videos. This configuration makes it possible to perform another display in which timings are adjusted to be concurrent only between a specific pair of the videos, for example. Moreover, the user is preferably able to designate to which reference video a video concerned is compared, through the use of controller 3.

Moreover, the process flow of the embodiment, in which the similarity between frames is calculated to designate the frame with the maximum similarity as the corresponding frame, may be modified in such a manner that: The procedure for designating the corresponding frame is modified to employ a calculation on a dissimilarity basis, instead of on a similarity bases. The dissimilarity-based calculation can directly use the indexes of dissimilarity which become larger in value with decreasing similarity between the images concerned. Such indexes of dissimilarity include SAD or SSD of the pixel values, differences in motion vectors, and the like. Then, the frame showing the minimum dissimilarity is designated as the corresponding frame. This modification eliminates the need for converting the indexes of dissimilarity into the indexes of similarity.

Moreover, in the video output device described above in the embodiments, each of the blocks may be configured with a one-chip device on a block basis, such as an LSI semiconductor device. Alternatively, a one-chip device may include a part or the whole of the blocks. Note that, the one-chip device is exemplified here by the LSI; however, it is sometimes called an IC, system IC, super LSI, or ultra LSI, depending on its scale of integration.

Moreover, the integration of blocks is not limited to such an LSI. The integration may be achieved using a dedicated circuit or a general-purpose processor. Instead, other devices may be used including: a field programmable gate array (FPGA) capable of being programmed after fabrication of the LSI, and a reconfigurable processor which allows the reconfiguration of interconnections and settings of the circuit cells inside the LSI.

Furthermore, it is naturally understood that the integration of the functional blocks may be realized using any of other technologies of circuit integration, which will replace current LSI technologies, based on progress of semiconductor technologies or derivative ones. A biotechnology or the like is possibly adopted.

Note that each of the aforementioned processes of the embodiments may be performed by hardware or software, or alternatively by a mix of hardware and software. When the digital camera according to the embodiments is operated using hardware, it goes without saying that a timing adjustment is necessary for performing each of the processes. In the embodiments described above, for convenience of the illustration, detailed descriptions of such a timing adjustment of various signals which has to be made in actual hardware designing are omitted.

As described above, the embodiments have been described to exemplify the technology according to the present disclosure. To this end, the accompanying drawings and the detailed descriptions are provided herein.

Therefore, the constituent elements described in the accompanying drawings and the detailed descriptions may include not only essential elements for solving the problems, but also inessential ones for solving the problems which are described only for the exemplification of the technology described above. For this reason, it should not be acknowledged that these inessential elements are considered to be essential only on the grounds that these inessential elements are described in the accompanying drawings and/or the detailed descriptions.

Moreover, because the aforementioned embodiments are used only for the exemplification of the technology disclosed herein, it is to be understood that various changes and modifications, replacements, additions, omissions, and the like may be made to the embodiments without departing from the scope of the appended claims or the scope of their equivalents.

The technology according to the present disclosure is applicable to video output devices which synthesize a plurality of videos into a video, thereby allowing the videos to be displayed on the same screen. Specifically, applications of the technology according to the present disclosure include a video server.

What is claimed is:

1. A video output device synthesizing a plurality of videos into a video to be displayed, the video output device comprising:
an image processing unit extracting a plurality of reference frames from any one reference video out of the plurality of the videos captured by an imaging unit, and extracting a corresponding frame most similar to each one of the reference frames from each of the videos excluding the reference video, wherein one of the respective reference frames and one of the corresponding frames are synthesized into a synthesized frame; and
an output unit outputting the synthesized frame.

2. The video output device according to claim 1, wherein the image processing unit includes:
a reference-frame extraction section extracting the plurality of the reference frames from the any one reference video out of the plurality of the videos captured by the imaging unit; and
a corresponding frame extraction section extracting the corresponding frame most similar to each one of the reference frames from the each of the videos excluding the reference video.

3. The video output device according to claim 1, wherein the videos captured by the imaging unit are captured at a frame rate higher than the frame rate output from the output unit.

4. The video output device according to claim 2, wherein the reference-frame extraction section of the image processing unit extracts the reference frames from the reference video at predetermined time interval.

5. The video output device according to claim 2, wherein the reference-frame extraction section of the image processing unit extracts the reference frames formed by averaging a predetermined number of consecutive ones of the frames of the reference video.

6. The video output device according to claim 2, wherein the corresponding-frame extraction section of the image processing unit extracts one frame, as the corresponding frame, showing a maximum similarity to the respective reference frames.

7. The video output device according to claim 2, wherein the corresponding-frame extraction section of the image processing unit extracts the corresponding frame formed by averaging a plurality of the frames included in the each of the videos excluding the reference video such that the corresponding frame shows a maximum similarity to the respective reference frames.

8. The video output device according to claim 2, wherein the corresponding-frame extraction section of the image processing unit calculates a similarity to each reference frame, based on a motion vector between the reference and corresponding frames.

9. The video output device according to claim 2, wherein the corresponding-frame extraction section of the image processing unit calculates a similarity to each reference frame, based on a difference in pixel values between the reference and corresponding frames.
